(19) United States
(12) Patent Application Publication
(10) Pub. No.: US 2023/0306327 A1
(43) Pub. Date: Sep. 28, 2023

(54) TECHNIQUES FOR DISCOVERING AND SHARING DIGITAL WORKFLOW TASK ASSIGNMENTS

(71) Applicant: INTERNATIONAL BUSINESS MACHINES CORPORATION, ARMONK, NY (US)

(72) Inventors: Peng Hui Jiang, Beijing (CN); ZHI LI GUAN, Beijing (CN); Kun Yang, Beijing (CN); Jun Su, Beijing (CN); Shi SS Su, Beijing (CN); Yun Diao, Beijing (CN)

(21) Appl. No.: 17/653,500

(22) Filed: Mar. 4, 2022

(51) Int. Cl. G06Q 10/06

(52) U.S. Cl. CPC G06Q 10/063112; G06Q 10/063114; G06Q 10/063116; G06Q 10/0633

(57) ABSTRACT

A method, computer system, and a computer program product for task management is provided. The present invention may include analyzing task requirements for a new task to be performed by a computer. The present invention may include determining when other tasks are to be performed at least partially simultaneously with said new task. The present invention may include determining one or more candidates engageable to perform said new task. The present invention may include generating a workflow for all tasks that are to be performed simultaneously and mapping said tasks with said engageable candidate task performer(s). The present invention may include determining skillset and availability of said one or more engageable candidates for performing said simultaneous tasks, said simultaneous tasks including said new task, and generating a confidence rating for each of said candidate task performers by analyzing said workflow and said candidate’s skillset, and availability for each simultaneous task.

### BACKGROUND

The present invention relates generally to the field of computing, and more particularly to techniques for creating and managing workflow task assignments.

An efficient way to perform computer tasks may be through the creation of digital workflow assignments. Creation of a workflow task assignment leads to an understanding of the processes that need to be completed for a successful task performance. Creating these types of workflows digitally has enabled tracking of all stages of their cycles so efficiency can be achieved, and work can be divided amongst task performers and automation. With automation being an option, digital workflows also help with the acquiring and/or creation of appropriate tools for task completion.

In most instances, a user or task master will create workflow applications to improve productivity. In a digital environment, workflow applications often coordinate work between tasks performed by humans and automated tasks to improve daily business operations. A task can be assigned to an individual as well as a group of candidates, either at design time (static) or at runtime (dynamic). This becomes a complex process when many tasks are being performed simultaneously.

One challenge may be that many task assignment selections are made during workflow design time or ahead of completion during runtime. It may be difficult to choose the best candidate or group when each candidate has a variety of skills or alternatively none associated with the performance of each task. Assigning tasks to a candidate (hereinafter interchangeably referenced as a task performer and/or digital workers) becomes very complicated in larger environments where there are many candidates and many tasks, and the tasks have multiple steps and are run simultaneously. Once tasks are assigned, there may be very little monitoring of their progress which compounds the problem. In these scenarios, by the time an issue arises that necessitates a change, task reassignments have already become too costly to be made.

Currently, prior art does not provide a comprehensive way to divide tasks or monitor their progress so that they can be successfully completed, especially in a complex environment. Consequently, it may be desirous to provide an optimal process that can manage digital tasks through correct task assignments and continuous monitoring.

### SUMMARY

To address problems associated with the prior art, a method, computer system and computer product is provided for task management with many advantages, one of which is providing a comprehensive way to divide tasks or monitor their progress so that they can be successfully completed, especially in complex environments.

In accordance with one aspect, a task management technique may be provided for task assignment and completion. In this embodiment, a new task may be analyzed and determined if other tasks are to be performed at least partially simultaneously with this new task. One or more candidates engageable to perform the new task are also determined. A workflow may be then generated for all tasks that are to be performed simultaneously. This workflow maps tasks with engageable candidates to perform the tasks based on their skillset and availability. A confidence rating may be then generated for each candidate by analyzing the workflow and the candidate’s skillset, and availability for each simultaneous task.

In accordance with another embodiment, task assignments are then made based on the confidence rating. In another embodiment, task completion may also be monitored progressively, and confidence ratings are updated. Task reassignments are then made when confidence ratings are changed. This provides an advantage of allowing for an optimal process that can manage digital tasks through correct task assignments and continuous monitoring.

In accordance with yet another embodiment, the information about the candidate(s) skillset and any history of prior other task performances and previous task assignments are stored in a knowledge base database. This provides the advantage of allowing for a better user experience, and encouraging collaboration and task assignments based on previous real performances.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2a illustrates an operational flowchart for building a knowledge-based database according to at least one embodiment;

FIG. 2b illustrates an operational flowchart architecture for building a knowledge-based database according to FIG. 2a as per one embodiment;

FIG. 3a illustrates a block diagram for task extraction workflow generated at design time for associate roles according to at least one embodiment;

FIG. 3b provides an example of task assignment data to a knowledge-based database according to at least one embodiment;

FIG. 4 illustrates a block diagram for generation of information for candidates to be provided to a knowledge-base database according to at least;

FIG. 5 illustrates a block diagram for a knowledge-base database after mappings generation between candidates and their skill sets according to at least one embodiment;

FIG. 6a illustrates a block diagram for a progressive workflow according to one embodiment;

FIG. 6b illustrates a block diagram for establishing task assignments according to one embodiment;

FIG. 7a illustrates a flowchart diagram used for workflow mapping according to one embodiment;

FIG. 7b illustrates a different path of the flowchart diagram of FIG. 7a according to the embodiment of FIG. 7a.

FIG. 8 illustrates a block diagram for constructing a progressive flow of confidence rating according to one embodiment;

FIG. 9 illustrates a block diagram having internal and external components of computers and servers such as depicted in FIG. 1 according to at least one embodiment;

FIG. 10 provides a block diagram of an illustrative cloud computing environment including the computer system depicted in FIG. 1, in accordance with an embodiment of the present disclosure;

FIG. 11 provides a block diagram of functional layers of the illustrative cloud computing environment of FIG. 10, in accordance with an embodiment of the present disclosure; and

FIGS. 12a and 12b provide a flowchart showing a task assignment methodology according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but may be not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for task management. As such, the present embodiment has the capacity to improve the technical field of task management and completion by more optimally assign tasks, automate at least part of such tasks and monitor the completion, and make timely reassignments as necessary.

In recent years, as described previously task management has become important as more and more processes become digitalized. In addition, in an environment that employs many people, the overall individual experience also impacts successful task completion. This has become more of a concern with the expansion of remote and hybrid work environment options. Individual experience reflects how effectively people interact with their workplace digital tools, which allows them to be engaged, proficient, and productive. Workflow designs have been very important in providing optimal task trafficking and successful task completion. With the incorporation of a more remote team and availability of automated resources, appropriate task assignments and an efficient workflow design increases flexibility, reduces operational costs, and improves overall productivity.

Workflow applications coordinate work between tasks performed by humans and automated tasks to improve daily business operations. Task assignment allow participants to work on a task in a workflow as a group or individuals. A task can be assigned to an individual as well as a group of candidates, either at design time (static) or at runtime (dynamic). The challenge may be that making appropriate selections are difficult and reassignments because of changed conditions or poor selections are costly. Better selections are often made when they are made at runtime and when task assignments are made based on a specific criterion.

Therefore, it may be advantageous to, among other things, to provide a technique to find best matching candidates for a certain task based on a certain workflow. Task assignment should be based on several criteria such as compatible skillset and candidate’s availability. It should also be desirous to have a confidence measure that indicates how successful the candidate would be in completing the task.

According to at least one embodiment, the present invention may provide a technique to assign tasks by analyzing existing workflows and extracting tasks that already engage one or more candidates (task performers). A knowledge base can be generated for every engageable candidate providing their skillset with a context and other relevant input (individual’s ID, years with the company etc.) and any previously relevant output (prior success in task completion) or other conditions or confidence indicators. In one embodiment, this will help in generating a mapping relationship for the candidate and their skill sets which will be stored in a database into the knowledge base. Similar information can be built into the database regarding tasks and their requirements. Ultimately the database can be used in making task assignments.

In one embodiment, once the task has been assigned, the traffic provided by the new workflow related to the task may be progressively analyzed and provided as an input to the database as well. This will help generate further descriptions and conditions relating to every task overtime. This in turn will help generate a list of preordered tasks and the candidate for them in subsequent future tasks during the workflow generation stage. In one embodiment, this iteration of every task flow and their mapping with the candidates, will be used in assigning future tasks and also with computing a confidence rate for successful task completion. Assigned tasks can also be monitored progressively and information about their execution by the candidate (person performing the task) can be captured and sent to the database as part of feedback. The latter can be used for historical purposes or for reassignments of tasks when necessary.

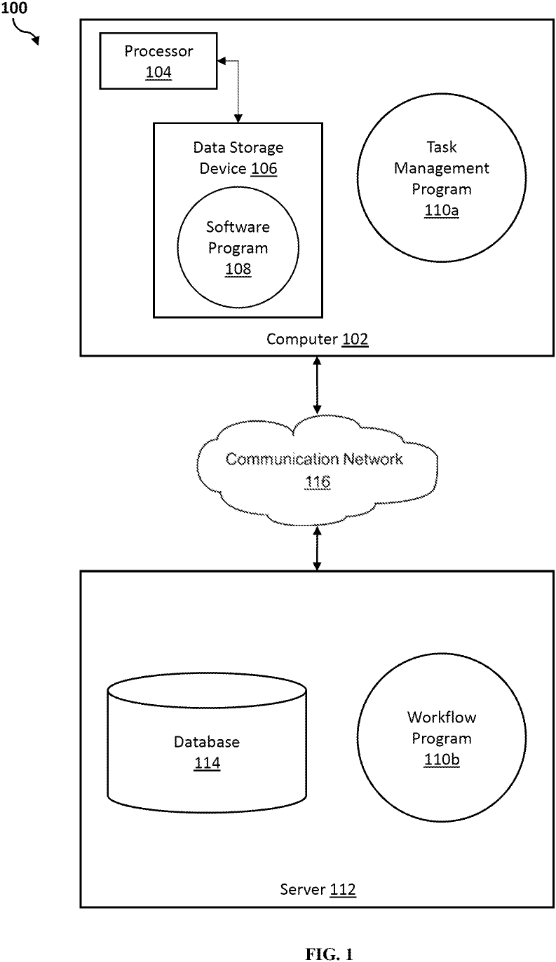

FIG. 1 provides for an exemplary networked computer environment 100 in accordance with one embodiment. The networked computer environment 100 may include a computer 102 with a processor 104 and a data storage device 106, enabled to run a software program 108 and a task management program 110a. The networked computer environment 100 may also include a server 112, enabled to run a workflow application or program 110b that may interact with a database 114 and a communication network 116. The networked computer environment 100 may include a plurality of computers 102 and servers 112, (only one shown). The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

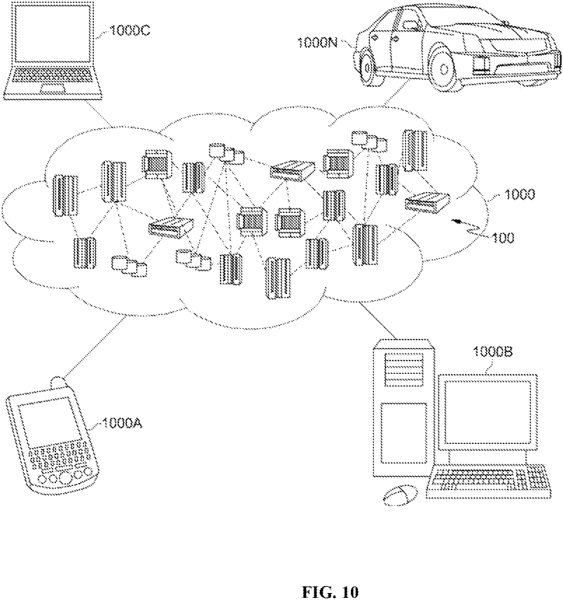

The client computer 102 may communicate with the server computer 112 via the communications network 116. The communications network 116 may include connections, such as wire, wireless communication links, or fiber optic cables. As will be discussed with reference to FIG. 9, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as an individualized cloud, community cloud, public cloud, or hybrid cloud. Client computer 102 may be, for example, a mobile device, a telephone, a digital assistant, a netbook, a laptop computer, a tablet computer, a desktop computer, or any type of computing devices capable of running a program, accessing a network, and accessing a database 114. According to various implementations of the present embodiment, task management application 110a, and workflow application/program110b may interact with a database 114 that may be embedded in various storage devices, such as, but not limited to a computer/mobile device 102, a networked server 112, or a cloud storage service.

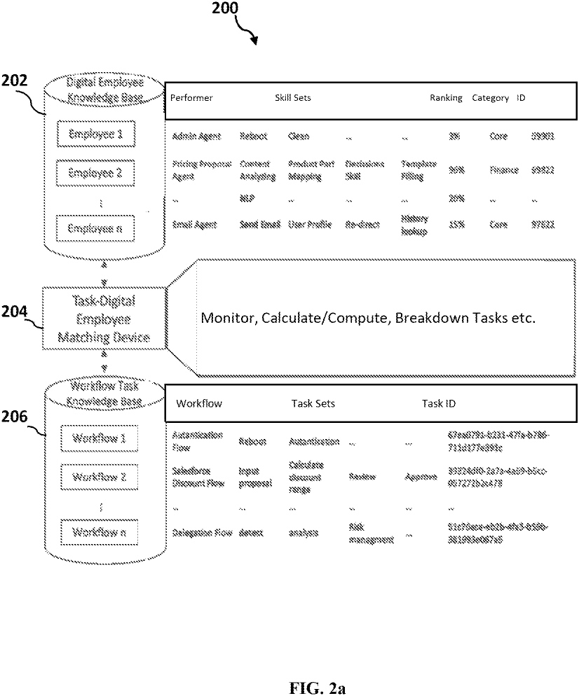

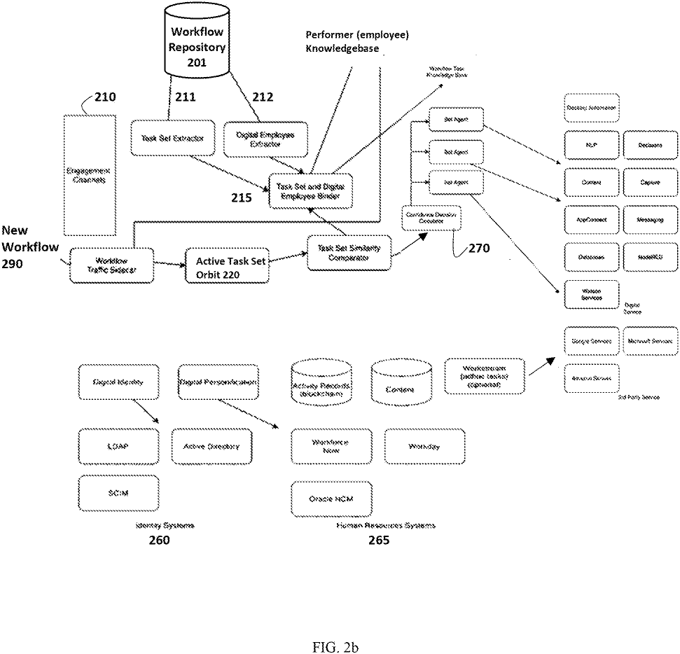

According to the present embodiment, a user using a client computer 102 or a server computer 112 may use the program 110a, 110b (respectively) to provide a task management technique. This technique will be provided in more detail below with respect to FIGS. 2 to 8.

FIGS. s 2-8, and 12 provide for techniques for managing a workflow in relation to completion of one or more tasks. Task assignment becomes challenging when a new task may be performed but this new task may run at least partially simultaneously with one or more tasks. To compound the problem, this new task may have the substantially the same requirements as other tasks that will be running simultaneously. In such a situation, the best candidates to perform the task may already be assigned to the other simultaneous tasks. Other scenarios may also exist where there are many candidates or alternatively no candidates with the skillset or availability to perform any of the tasks. In these scenarios, the selection process becomes even more important because the candidate that can complete each task more skillfully and in quickest time needs to be assigned to that task. This should create a hierarchy of assignments amongst tasks and candidates. For example, if A and B and C can all perform task 1 but A may be more skillful than B, the logical conclusion may be for A to be assigned the task. However, when task 2 has to be also completed simultaneously and only A has the skillset to complete it, then task 1 should not be assigned to A to allow A to be assigned to task 2. Alternatively, in a different scenario, candidates A and B and C are all new and do not have a skillset needed for to task 1 but candidate A can skill perform task 2 and candidate C can perform task 3. Therefore, B should be assigned to perform task 1. This may necessitate some reassignments of tasks if some of the simultaneous tasks have been assigned to certain candidates before a new tasks execution request may be received. The techniques provided in FIGS. 2-8, and 12 address some of these concerns.

FIGS. 2-8, and 12 generally provide according to one embodiment a method and or a system having a processor that may be configured to provide the method. The candidate may be incorporated and assigned one or more workflow tasks after task criteria and individual’s data may be analyzed to determine skillsets and existing workflows. This analysis will generate the knowledge base for every candidate that provides a context that associates their skill to the task(s). This will allow a mapping relationship to be constructed that associates tasks with candidate (can also use it later as part of a developed and stored knowledge base for future tasks). In one embodiment, a workflow may be established and then analyzed progressively (based on the input and condition for each task) to determine if the assignments are made optimally. This can lead to an interim determination of tasks are they are relegated to different users. The process may be iterated for every task flow route and analyzed to provide an optimal final solution (based on the generated mapping flow in the stored knowledge base database). Once the optimal task flow routs and candidates are determined, a confidence rate may be computed for each actor (candidate) for each task. If the rates are acceptable the tasks may be assigned but their execution are monitored and appropriate feedback may be generated and stored in the knowledge base database for future use (this may include several input and output generated and other conditions present and the confidence ratings calculated.

Referring now to FIGS. 2a and 2b specifically, an operational flowchart illustrating the exemplary process 200 of building a knowledge base according to at least one embodiment may be depicted. The knowledge-base may be a database including information that will be used to create workflows used for task assignments. The knowledge-base may be constructed with two grouping of information, one that pertains to candidates and second that pertains to tasks. The first referenced by numerals 202 includes information about candidates (task performers). As shown the database associates a plurality of candidate with their skillset and rank for each skill set. As shown, a variety of skills can be associated with each candidate. Other criteria may also be entered as shown here as way of an example. In this embodiment, the criterion selected for ease of understanding and as way of example, include title of the individual (role in the company), engaged tasks and other execution contexts associated with the skill such as candidate subsequent tasks and attributes, etc. In other embodiments, other execution contexts (including input, output, condition, and confidence) can be selected as well as the task and other individual attributes.

The second information grouping in the knowledge base relates to tasks and workflows (206). There may be a plurality of new or historical workflows having several running or completed tasks. There may also be an established task queue for current tasks. shown. Many attributes can be also placed in this database in different alternate embodiments. In this example for ease of understanding, the database includes a set of preordered tasks and the future candidate subsequent tasks. Other attributes and other required skills for the task are also provided here.

In one embodiment as shown in FIG. 2a, aTask-Digital Matching Device (TDEMD) 204 may be provided that has access to information in both portion of database 202 and 206. TDEMD monitors the execution of the performers of each task (individual performers) and can send feedback to either to 202 and 206 or to other computing components. It also computes a confidence rate for each candidate per (digital performer) for each current task. In this manner the most suitable candidates can be determined and selected based on a list of current or to be processed tasks. In performing this determination, the skills for each certain task may be also calculated and determined so that appropriate candidates (digital performer) can be assigned future as well as current tasks. The performance of each task and its performance (by candidate) will also be continuously monitored and feedback may be sent back to either 202 or 206 or both.

FIG. 2b provides a block diagram illustration according to one embodiment. In this example, the embodiment of FIG. 2a has been implemented. Once a task has been identified (new workflow 290), the Engagement channel 210 analyzes a variety of components. This may involve components - task set extractor 211 and digital performer extractor 212. In this embodiment, this will associate tasks and performers available to conduct the task. This information may then be placed in a record or file identified here as the Task set and digital performer binder 215. This binder can include previous tasks or skillset data that will be reviewed by a task set similarity comparator 220. The task set similarity comparator 220 may include other components in alternate embodiments and will be used with other components to provide a final confidence rating (confidence decision calculator 230.) This will be provided to the databases 202 and 206, and also used to engage in starting one ore more automated processes (through bots etc.). The Engagement channel 210 may also utilize other components like Identity systems 260 or human resources centers 270 etc.) to further help calculate the confidence decision rate and distribute work. This may be a reiterative process and there may be communication and data exchange and storage in the workflow repository 201 (and the workflow process 290 itself).

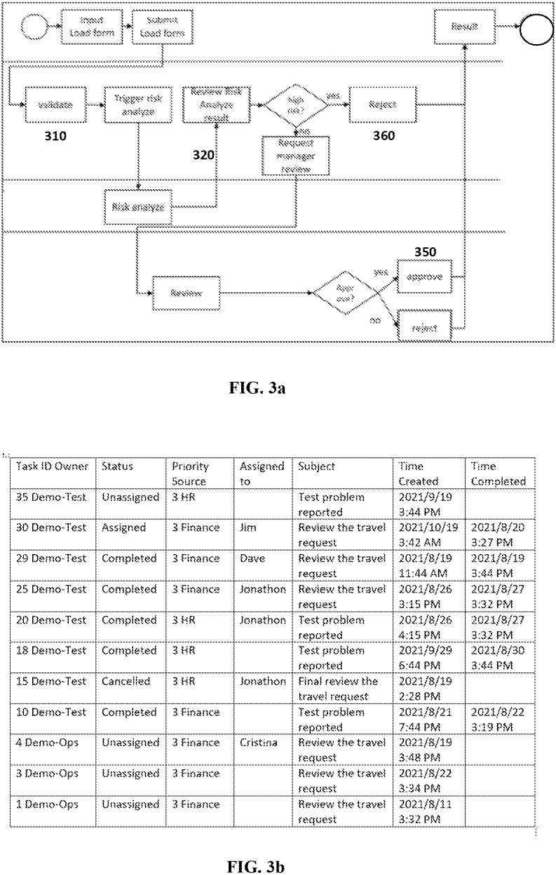

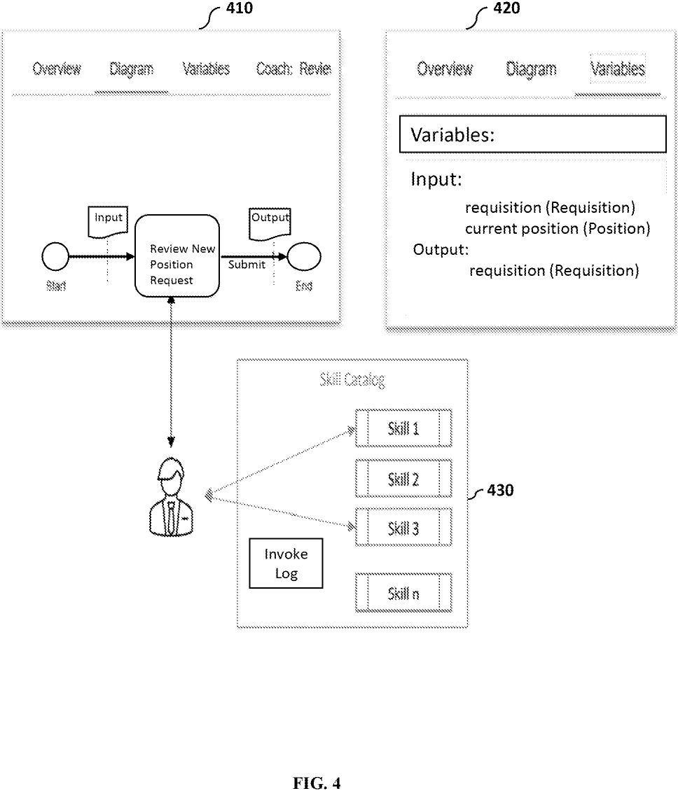

FIG. 3a provides a flowchart illustration of some of the details that were discussed in FIGS. 2a and 2b. For ease of understanding, FIG. 3b can be used as an example of tasks that may need completion. Furthermore, FIG. 3b can be a repository database as discussed that provides different stages of task assignment and task request.

In FIG. 3a, tasks associated (engaged) with performers are extracted through two manners (dimensions). Previously in FIGS. 2a and 2b, the task’s associated role which might have been defined at design time can be determined. This involves getting the task’s associated role which in one embodiment can include a combination of individuals (single users and/or performer) and groups. This leads to an analysis step where it may be determined whether the performers are correctly associated with their roles based on their skillset. The task’s executor may be assigned at runtime (dynamic task assignment) then extracts the tasks and further analyze the historical task execution records in order to determine which candidate should be finally assigned each task. In one embodiment, a further check may be made subsequently to ensure that the candidate has been assigned to the tasks and has commenced it. In FIG. 3a, the confidence may be taken a step further and the risk of associating a performer may be analyzed for each task as shown at 310. It can then be determined at 320 how much risk may be associated with each task and person and based on the result and analysis it may be determined if the assignment should be rejected 360 or approved at 350. These assignments will then be provided back in the repository shown in FIG. 3b where task assignments and request are provided as discussed earlier.

As discussed, tasks associated are extracted and provided in the knowledge base for every candidate for later use such as in one embodiment in the repository. In one embodiment, a context (as how previously the task was performed and the reason for the task) may be provided. This can include previous inputs, outputs, conditions, and confidence ratings provided with the previous task.

In one embodiment, when extracting information for new assignments to be made, the extracted information can include (beside whether the candidate being currently engaged in a current workflow task), data including:
Name - a string of characters uniquely identifying the task;
Input - Boolean expressions that must be true before the action(s) of the task can take place;
Output - Boolean expressions that must be true after the action(s) of the task do take place;
Condition - providing indications of the type and quantity of resources necessary for the execution of the task, the candidates in charge of the tasks, the security requirements, whether the task may be reversible or not, and other task characteristics; and
Required skills

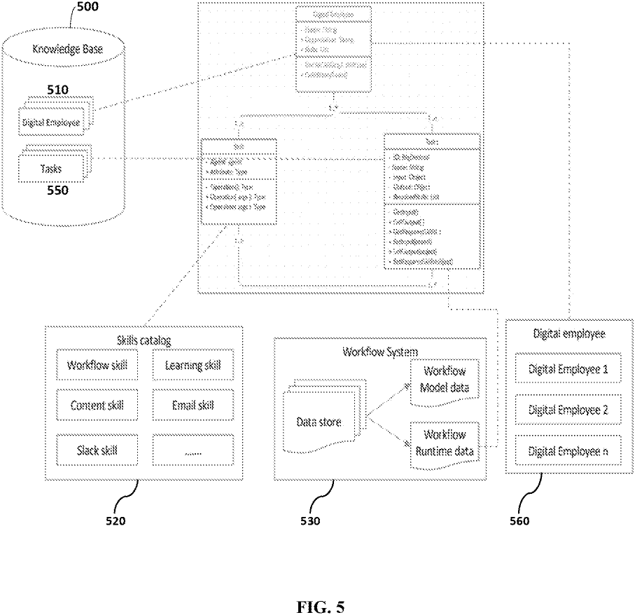

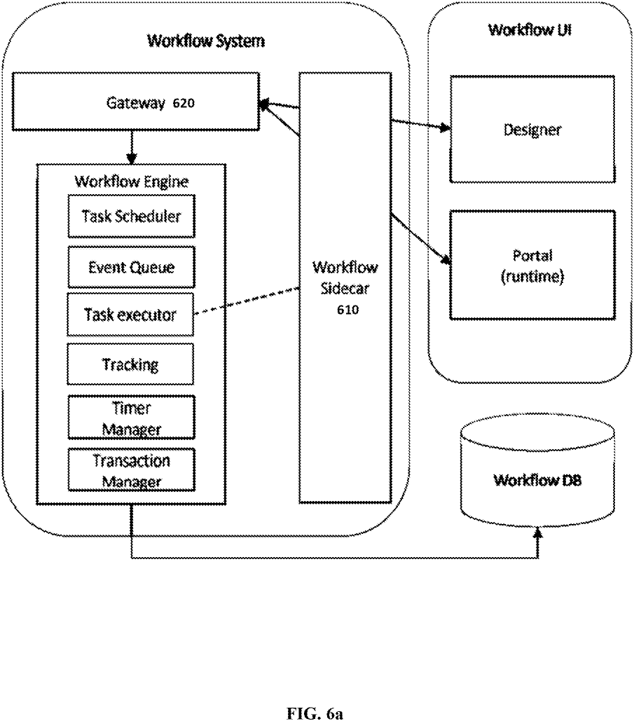

In alternate embodiments, as can be appreciated by those skilled in the art, a variation of these can be present and other information can be inserted and information can be extracted from the candidate knowledge base that may also have a bearing on the current task assignment(s). To more easily assess the necessary information for task assignment, in one embodiment a knowledge base may be generated for each candidate as discussed. In example provided above, generating the knowledge base includes the context, including input, output, condition, and confidence. An example may be the block diagram of FIG. 4. As shown in FIG. 4, when a new task may be received at 410, the data may be extracted at 420/430 from the repository to assign candidates for each new task. A more expansive view of the process, combining FIG. 4 with the previous FIGS. (2 and 3) as shown in FIG. 5.

In FIG. 5, the knowledge base repository with mappings between candidates (Digital) and their skill set may be provided. As can be seen in knowledge base 510, the entries for each candidate may be provided at 510 which can include a range of options 512, 514 and 516 as discussed earlier. The tasks 550 that are to be performed or were previously performed are also provided in the repository 510. The skills 514 and other related tasks performed 516 are analyzed versus task list 550. This may be then compared to an overall of what may be available (for different task performers) overall as shown in 520 and what needs to be done and the overall of the workflow (simultaneous tasks etc.) as shown at 530 so that a resulting assignment can be provided based on available candidate/task performer at 560.

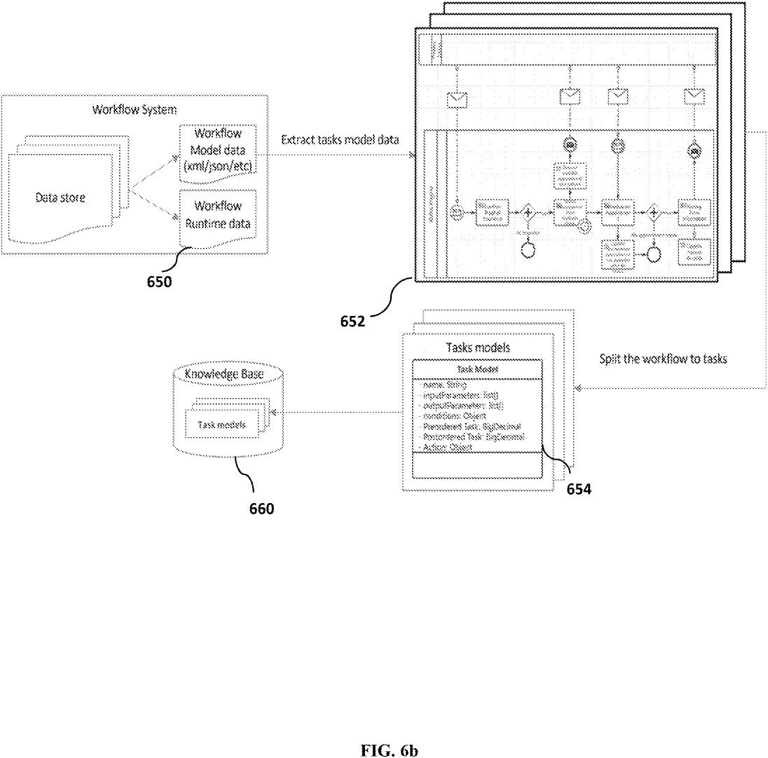

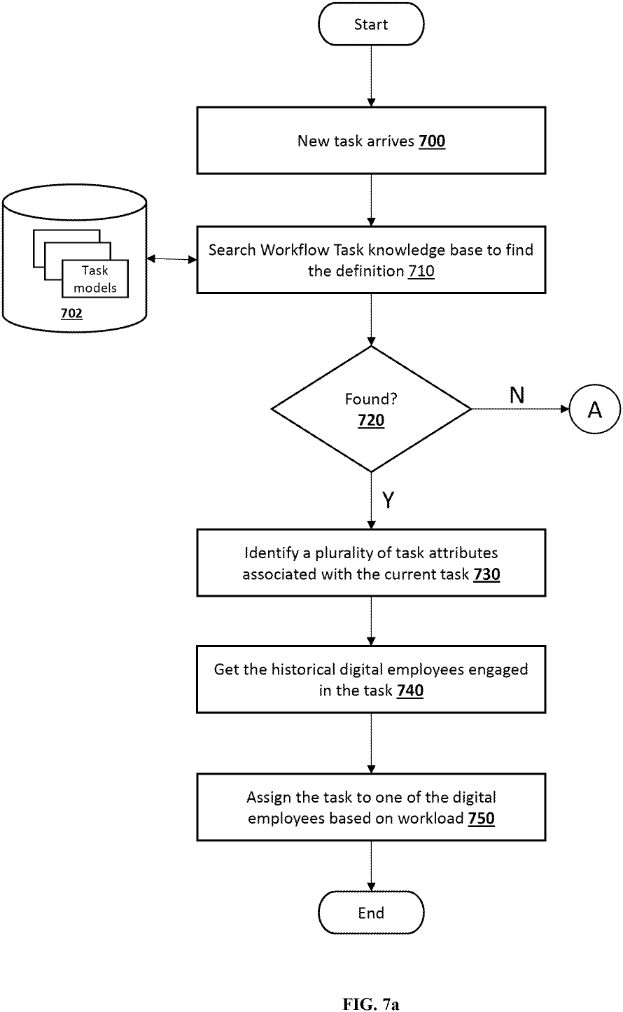

In alternate embodiments some other components can be added to even make the process of FIG. 5 more efficient. Some of these examples are provided in FIGS. s 6a and 6b. For example, in FIG. 6a, a sidecar can be provided in the process to capture any traffic in a new workflow so as to allow for a progressive analyze may be of the input and other dynamic and developing conditions for each task being performed. As shown in the embodiment shown in FIG. 6a, the sidecar 610 can be placed in a workflow gateway 620 to capture the traffic. In this example, then all the traffic will be routed to go through the sidecar, so that the sidecar can capture each task’s execution data including input, output and other present conditions.

As shown in FIG. 6a with the sidecar, to achieve better efficiency tasks can further be split in different embodiments. FIG. 6b provides an example where the model may be built in a way as to provide a more detailed description set for each task. This may provide a complex stion as to how the tasks should be arranged (ordered) so that the model includes this preordered task list and a candidate for performing each subsequent task. As discussed earlier, this becomes important when several of tasks have to be performed simultaneously. Assigning candidates becomes very complex and this model will be needed if x number of tasks are to be performed and y number of them are to be performed simultaneously over a t time period. Changing even one candidate will affect everyone else’s assignment and order of who performs which task at one time in such a scenario.

In the embodiment of FIG. 6b, this concept gets extended further. A workflow system 650 may be designed by using the available data. A model system may be then envisioned that extracts model data for such a task. The model data splits the task into more workable components to provide efficiency as shown in 652. Once the task models are determined 654 and split, the task models are then provided to the knowledge base 660. Then the process of FIG. 6a can be reiterated or commenced for the first time.

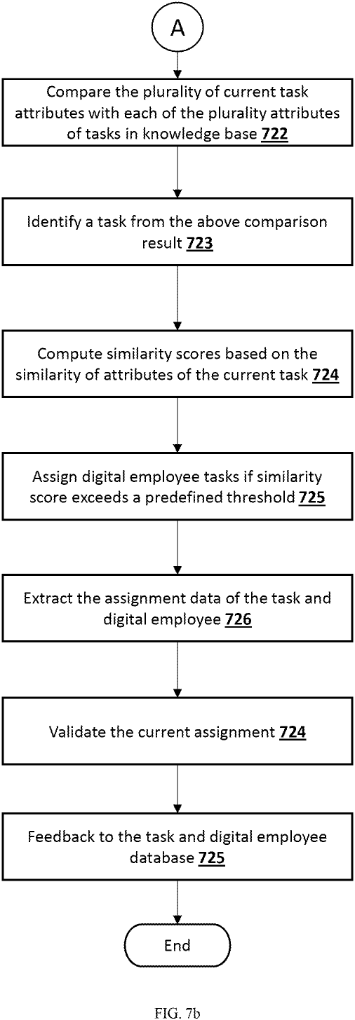

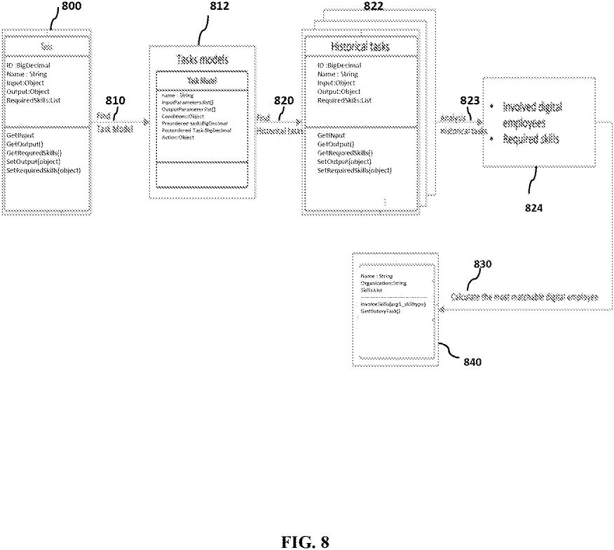

FIGS. s 7a and 7b provides a flowchart representation according to one embodiment. The process begins in FIG. 7a when a task arrives as shown in 700. One or more knowledge bases are then searched to find the workflow at 710 and one or more task model(s) 702 in at least one knowledge base database are researched. a task database. Once a task has been found (720), one or more task attributes associated with the associated current task(s) may be identified as shown at 730. In this embodiment, historical data associated with the candidate/task performer are also recovered as shown at 740 and the task may be then assigned at 750 based on a number of factors including what may be determined from 730 and 740 and the candidate (task performer) current workload.

In the case that searching the Task knowledgebase does not provide a Task, a different path may be followed as shown in FIG. 7b. In this case, a plurality of (current) ask attributes are compared with each and any task attributes that may be similar but not identical as found in the knowledge base (722). A close or relatively similar task may be then identified as shown at 723 and a similarity score may be then computed based on the similarity attributes found in 723 as shown in 724. Based on the result generated in 724, tasks can be assigned to an candidate in 725. In one example shown at 725 this may be based on exceeding a particular score threshold level. The assignment data of the task and the candidate (task performer) are both extracted (726) so the results for current task assignment can be validated (727). In one embodiment, the feedback to the task and the candidate are also provided to the knowledge base (728).

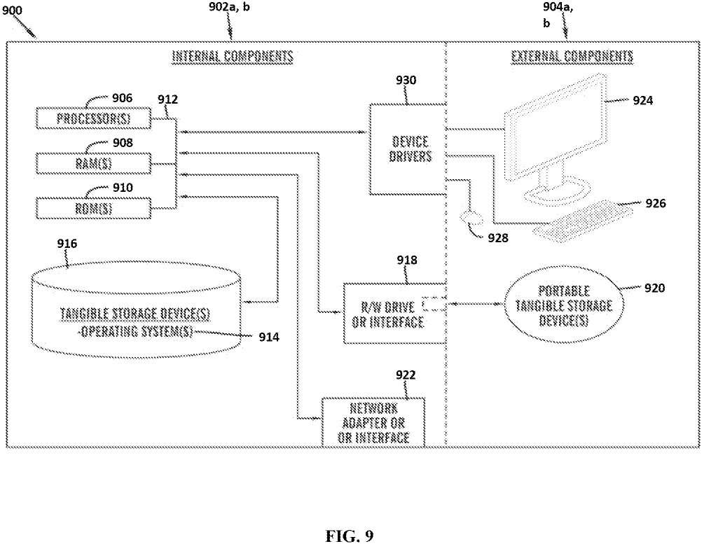

FIG. 8 provides a block diagram according to one embodiment for computing a confidence rate for each candidate (Task performer) for a current task. This Figure can be taken together with embodiment discussed in FIGS. s 7a and b to provide an ease of understanding. As discussed in FIGS. s 7a and 7b, the process starts when a task needs to be accomplished. In FIG. 8, a set of tasks to be accomplished and their associated information may be provided at 800. The search to find task models shown at 810/812 may be similar to 710. In the same manner as 722/723, historical tasks are also searched at 820/822 and analyzed 823 to find contribution and tasks skills of each candidate 824. This will allow the skill rating and performance of each candidate so that the best match for each task may be provided at 830 (similar to 725). All data relating to the task and candidate (task performer) will be denoted and can be stored as desired (840).

It may be appreciated that FIGS. 2-8 provide only an illustration of one embodiment and do not imply any limitations with regards to how different embodiments may be implemented. Many modifications to the depicted embodiment(s) may be made based on design and implementation requirements.

FIG. 9 provides a block diagram 900 of internal and external components of computers depicted in FIG. 1 in accordance with an illustrative embodiment of the present invention. It should be appreciated that FIG. 9 provides only an illustration of one implementation and does not imply any limitations with regard to the environments in which different embodiments may be implemented. Many modifications to the depicted environments may be made based on design and implementation requirements.

Data processing system 902, 904 may be representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, home computers and other individualized workstations and computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a,b and external components 904a,b illustrated in FIG. 9. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the task management program 110a in client computer 102, and the workflow program 110b in network server 112, may be stored on one or more computer-readable tangible storage devices 916 for execution by one or more processors 906 via one or more RAMs 908 (which typically include cache memory). In the embodiment illustrated in FIG. 9, each of the computer-readable tangible storage devices 916 may be a magnetic disk storage device of an internal hard drive. Alternatively, each of the computer-readable tangible storage devices 916 may be a semiconductor storage device such as ROM 910, EPROM, flash memory or any other computer-readable tangible storage device that can store a computer program and digital information.

Each set of internal components 902a,b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the task management 110a and workflow program 110b can be stored on one or more of the respective portable computer-readable tangible storage devices 920, read via the respective R/W drive or interface 918 and loaded into the respective hard drive 916.

Each set of internal components 902a,b may also include network adapters (or switch port cards) or interfaces 922 such as a TCP/IP adapter cards, wireless wi-fi interface cards, or 3G or 4G wireless interface cards or other wired or wireless communication links. The software program 108 and the task management program 110a in client computer 102 and the workflow program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the task management program 110a in client computer 102 and the workflow program 110b in network server computer 112 are loaded into the respective hard drive 916. The network may comprise copper wires, optical fibers, wireless transmission, routers, firewalls, switches, gateway computers and/or edge servers.

Each of the sets of external components 904a,b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It should be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing provides a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There may be a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer can use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer can be deployed onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer may be to provision processing, storage, networks, and other fundamental computing resources where the consumer may be able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Individualized cloud: the cloud infrastructure may be operated solely for an organization. It may be managed by the organization or a third party and may exist on-premises or off-premises.

Community cloud: the cloud infrastructure may be shared by several organizations and supports a specific community that has shared concerns (e.g., mission, security requirements, policy, and compliance considerations). It may be managed by the organizations or a third party and may exist on-premises or off-premises.

Public cloud: the cloud infrastructure may be made available to the general public or a large industry group and may be owned by an organization selling cloud services.

Hybrid cloud: the cloud infrastructure may be a composition of two or more clouds (individualized, community, or public) that remain unique entities but are bound together by standardized or proprietary technology that enables data and application portability (e.g., cloud bursting for load-balancing between clouds).

A cloud computing environment may be service oriented with a focus on statelessness, low coupling, modularity, and semantic interoperability. At the heart of cloud computing may be an infrastructure comprising a network of interconnected nodes.

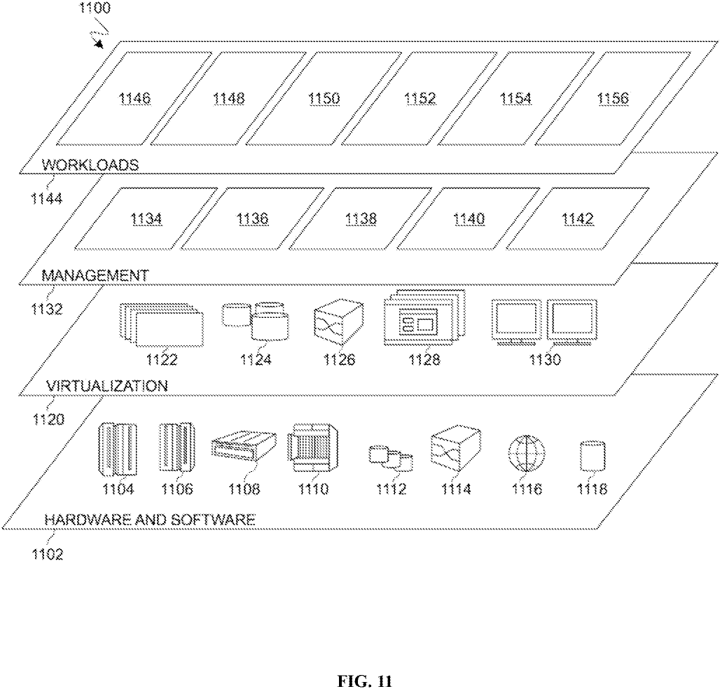

FIG. 10 illustrates a cloud computing environment 1000. As shown, cloud computing environment 1000 comprises one or more cloud computing nodes 100 with which local computing devices used by cloud consumers, such as, for example, any kind of digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Individualized, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It should be understood that the types of computing devices 1000A-N shown in FIG. 10 are intended to be illustrative only and that computing nodes 100 and cloud computing environment 1000 can communicate with any type of computerized device over any type of network and/or network addressable connection (e.g., using a web browser).

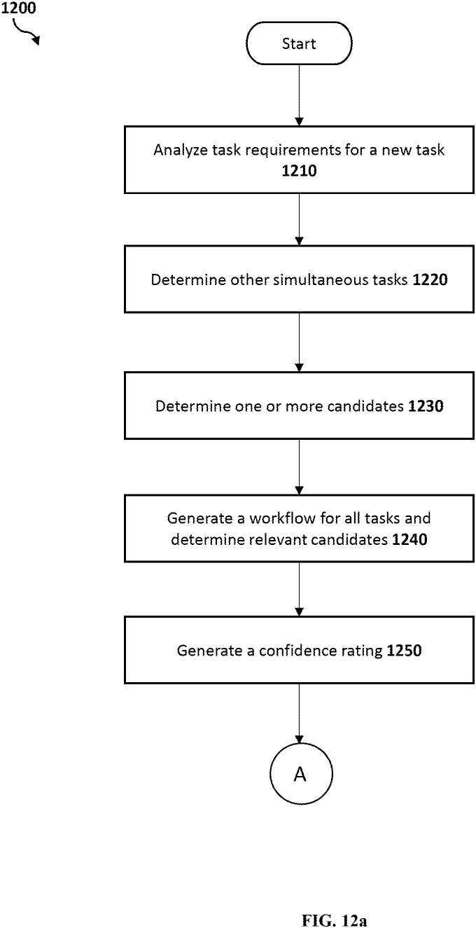

Referring now to FIG. 11, a set of functional abstraction layers 1100 provided by cloud computing environment 1000 as shown. It should be understood in advance that the components, layers, and functions shown in FIG. 11 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual individualized networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement may be anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data management 1156.

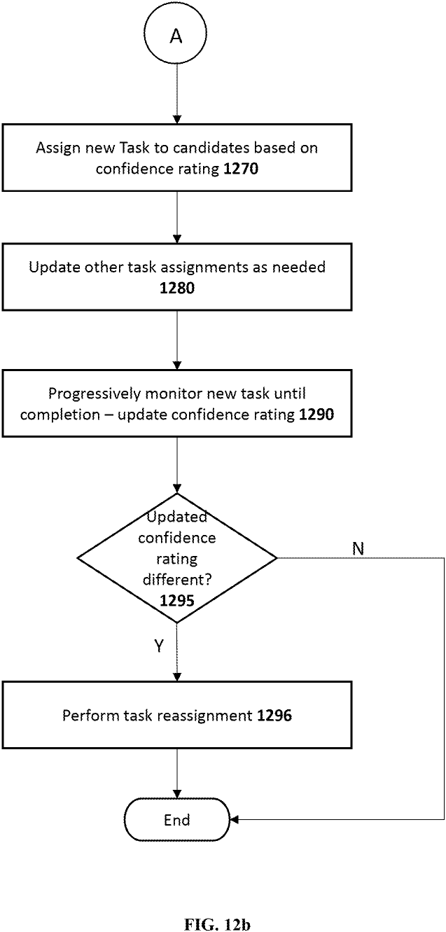

FIGS. 12a and 12b provide a flowchart illustration as per embodiment. In FIG. 12a, as shown the process 1200 starts after receiving a new task. The new task may then be analyzed at step 1210 and its requirements are determined so the new task can be performed by the computer. The task may have one or a plurality of components that needs to be analyzed. As shown in step 1220, it may also be determined where there are other tasks that have to be performed with this new task at least partially simultaneously. As shown in step 1230, the candidates that can be engageable to perform the new task are then determined. In step 1240 a workflow may then be generated that includes a determination of all tasks that are to be performed simultaneously and this information (between the candidates and tasks) are mapped. The tasks are then mapped to the engageable candidate task performers based on determining the skillset and availability the engageable candidates for performing all simultaneous tasks. In step 1250 a confidence rating may be then generated based on the analysis of the information regarding the (engageable) candidates and the tasks. Tasks are then assigned based on this confidence rating as shown in step 1270.

In one embodiment, assigning the new task may also include reassignment of other already assigned simultaneous tasks differently and this change may be performed as appropriate as shown at 1280. In one embodiment, the performance of the new task will be monitored to completion as sown in step 1290 completion will be progressively monitored until completion and said new workflow may be progressively analyzed and said confidence rating(s) may be updated. As shown in step 1295, confidence ratings are also updated and where there may be a substantial change, a reassignment of one or more tasks including the new task may be performed prior to the process ending in step 1299.

The different embodiments provided above provides for an optimal manner to assign tasks based on previous history and performance completion. This will improve user experience, reduce maintenance resource management, and enhance collaboration between tools and individuals and amongst colleagues in a team or on a project.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for task management, the method comprising:
analyzing task requirements for a new task to be performed by a computer;
determining when other tasks are to be performed at least partially simultaneously with said new task;
determining one or more candidates engageable to perform said new task;
generating a workflow for all tasks that are to be performed simultaneously and mapping said tasks with said engageable candidate task performers;
determining skillset and availability of said one or more engageable candidates for performing said simultaneous tasks, said simultaneous tasks including said new task; and
generating a confidence rating for each of said candidate task performers by analyzing said workflow and said candidates skillset and availability for each simultaneous task.

2. The method of claim 1, further comprising assigning said new task to at least one candidate task performer based on said confidence rating.

3. The method of claim 2, further comprising updating task assignments of other simultaneous tasks and reassigning tasks to other candidates when new task assignment requires such reassignment.

4. The method of claim 3, wherein performance of said new task completion will be progressively monitored until completion and said new workflow is progressively analyzed and said confidence rating(s) updated.

5. The method of claim 4, wherein task re-assignment are made if said updated confidence ratings becomes different than said previous confidence rating.

6. The method of claim 2, wherein information about said candidate skillset and any history of prior other task performances and previous task assignments are also stored in said knowledge base database.

7. The method of claim 6, wherein confidence ratings associated with said task and task assignments to said candidate task performers are stored in a knowledge-based database.

8. The method of claim 7, further comprising storing said task workflow in said knowledge-base database.

9. The method of claim 8, wherein a new workflow for said new task being performed is and monitored and progressively analyzed and input and condition for each task is stored in said knowledge-based database.

10. The method of claim 9, further comprising generating a new workflow based on task traffic and completion after commencing said task performance.

11. The method of claim 10, further comprising generating said confidence rating by searching said knowledge-base database to find information about previous task flows and candidates prior task completion history; and using said information in generating said confidence rating, wherein said information includes previous task workflows and task completion data and information relating to candidates including any previous assignments, success in completing previous tasks and prior confidence ratings.

12. The method of claim 11, further comprising generating a description for each task already performed and storing said description and said associated task in said knowledge-based database, and analyzing the generated description and data about previous tasks in analyzing to see if any similarities exists between said previous tasks and said new task.

13. The method of claim 12, wherein said information about said candidate task performers stored in said knowledge-base database includes said candidate(s) skillset, previous confidence ratings for different tasks, task assignments and previous history of successful task completions.

14. The method of claim 13, wherein task assignments for candidates are provided based on an associated score on a hierarchy of confidence rating scores calculated for each task.

15. A computer system for task management, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing task requirements for a new task to be performed by a computer;
determining when other tasks are to be performed at least partially simultaneously with said new task;
determining one or more candidates engageable to perform said new task;
generating a workflow for all tasks that are to be performed simultaneously and mapping said tasks with said engageable candidate task performers;
determining skillset and availability of said one or more engageable candidates for performing said simultaneous tasks, said simultaneous tasks including said new task; and
generating a confidence rating for each of said candidate task performers by analyzing said workflow and said candidate’s skillset, and availability for each simultaneous task.

16. The computer system of claim 15, further comprising assigning at least one candidate task performer to perform said new task based on said confidence rating, and assigning and/or reassigning other simultaneous tasks to other candidate task performers based on said confidence rating.

17. The computer system of claim 16, wherein information about task workflow, task performance and information about candidates to perform said tasks are stored in a knowledge-based database.

18. The computer system of claim 17, further comprising progressively monitoring and analyzing performance of said new tasks; and updating said confidence rating as appropriate until completion of said new task.

19. The computer system of claim 18, wherein task re-assignment are made if said new confidence ratings are very different than said previous confidence rating.

20. A computer program product for task management, comprising:
one or more non-transitory computer-readable storage media and program instructions stored on at least one of the one or more tangible storage media, the program instructions executable by a processor to cause the processor to perform a method comprising:
analyzing task requirements for a new task to be performed by a computer;
determining when other tasks are to be performed at least partially simultaneously with said new task;
determining one or more candidates engageable to perform said new task;
generating a workflow for all tasks that are to be performed simultaneously and mapping said tasks with said engageable candidate task performer(s);
determining skillset and availability of said one or more engageable candidates for performing said simultaneous tasks, said simultaneous tasks including said new task; and
generating a confidence rating for each of said candidate task performers by analyzing said workflow and said candidate’s skillset, and availability for each simultaneous task.
